(19) United States
(12) Patent Application Publication
(10) Pub. No.: US 2019/0180364 A1
(43) Pub. Date: Jun. 13, 2019

(54) METHOD AND SYSTEM FOR EFFICIENT SWITCHING OF DIRECT DEPOSIT PAYMENT DESTINATION ACCOUNT

(71) Applicant: Acorns Grow Incorporated, Irvine, CA (US)

(72) Inventors: Jike Chong, Sunnyvale, CA (US); Manning Field, Laguna Niguel, CA (US); Charles Deutsch, Marina Del Rey, CA (US); Paige Conrad, Irvine, CA (US); Skylar Hartman, Corona Del Mar, CA (US); Jeremy Greene, Mission Viejo, CA (US)

(21) Appl. No.: 16/210,339

(22) Filed: Dec. 5, 2018

Related U.S. Application Data
(60) Provisional application No. 62/598,127, filed on Dec. 13, 2017.

(51) Int. Cl. G06Q 40/02; G06Q 20/32; G06Q 20/40

(52) U.S. Cl. CPC G06Q 40/02; G06Q 20/4014; G06Q 20/3223; G06Q 20/3221

(57) ABSTRACT

A switching of direct deposit payment destination account with a single action is initiated by a user of a finance service. A server system receives user information from a client system, assigns a client identifier to the client system, and associates the assigned client identifier with the received user information. The server system sends to the client system the assigned client identifier and information identifying the employer for one or more direct deposit payment and including a switch button. The client system receives and stores the assigned client identifier and receives and displays the information to the user. In response to activation of the switch button, the client system sends to the server system a request to switch the identified payment to the financial services account information on the server system. The server system generates a direct deposit switching request in accordance with the requirements of the employer.

### CROSS-REFERENCE TO RELATED APPLICATION

This application claims priority to U.S. Provisional Patent Application No. 62/598,127, entitled “Method and System for Efficient Switching of Direct Deposit Payment Destination Account,” filed on Dec. 13, 2017, the contents of which are herein incorporated by reference in their entirety.

### BACKGROUND

Services are being conducted over the Internet and the Mobile Internet, which comprise a vast number of client devices in communication with servers to complete transactions. Users produce transactions using client devices that run applications to communicate with servers, which are utilized by service companies to provide services. One such type of transaction are direct deposit transactions initiated by employers to compensate their employees and/or contractors.

Currently, employees and/or contractors can request their employers to directly deposit each month's paycheck, for example, into specific bank accounts. These request processes often involve completing long forms that may be time consuming and inconvenient for the employees and/or contractors.

### SUMMARY

Aspects of the current subject matter relate to a method and system to simplify an approach to one click or tap on client devices to allow a direct deposit payment destination account to be changed easily.

In some aspects, a method is provided. The method includes storing user information, user prior direct deposit records, employer information in data storage mediums, and displaying information on employer information to users on the client devices, and in response to a single action being performed, including but not limited to a click, tap, swipe, voice command, body gesture, finger-print authentication or face recognition authentication to generate a request to switch the direct deposit payment destination.

According to one aspect, a method of switching a direct deposit payment destination account includes: displaying, under control of a client system, information identifying an employer; sending, in response to a single action being performed, a request to switch a direct deposit payment destination, along with an identifier of a user making the switch, to a server system; receiving, at a single action switch component of the server system, the request; retrieving, at the server system and in response to the receiving, additional information previously stored for the user identified by the identifier in the received request; generating a second request to switch the direct deposit payment destination for the user identified by the identifier in the received request using the retrieved additional information; and fulfilling the generated request to complete switch of the direct deposit payment destination, wherein a process of switching direct deposit payment destination can be started without using multiple user interaction steps.

In some variations, one or more of the features disclosed herein including the following features can optionally be included in any feasible combination. The displaying of information may include displaying information indicating the single action. The single action may be one of clicking or tapping a button, speaking a sound, a facial movement, a facial gesture, or a body gesture. A user of the client system does not need to explicitly identify themselves when placing an order.

In an inter-related aspect, a client system for switching of direct deposit payment destination account may include: an identifier that identifies a user; a display component for displaying information identifying the employer of the direct deposit payment; and a single action switching component that, in response to performance of a single action, sends a request to a server system to switch direct deposit payment destination account, the request including the identifier so that the server system can locate additional information needed to complete the switch and so that the server system can fulfill the generated request to complete switching of the direct deposit payment destination.

In some variations, one or more of the features disclosed herein including the following features can optionally be included in any feasible combination. A process of switching direct deposit payment destination can be started without using multiple user interaction steps. The display component may be a browser or a mobile app. The single action may be one of a clicking of a mouse button, a tap of a touch screen device, a voice, a finger print, a biometrics identifier, a facial movement, a camera image, a video, or a body gesture.

In an inter-related aspect, a server system for switching of direct deposit payment destination account may include: a direct deposit payment destination switching processor component; and a single action direct deposit payment destination switching component including: a data storage medium configured to store information for a plurality of users; a receiving component configured to receive a request to switch direct deposit payment destination, the request including an indication of one of the plurality of users, the request sent in response to only a single action being performed; a direct deposit payment destination switching component configured to retrieve from the data storage medium information for the indicated user and that uses the retrieved information to switch the direct deposit payment for the indicated user for an employer; and a direct deposit payment destination switching processor component that completes the switch in accordance with the order placed by the single action ordering component. The request may be sent by a client system in response to a single action being performed.

In another inter-related aspect, a method for switching of a direct deposit payment destination account using a client system includes: displaying, on a user interface of the client system, information identifying an employer of a direct deposit payment and displaying an indication of a single action that is to be performed to switch direct deposit payment destination account; and sending, in response to the indicated single action being performed, to a server system a request to switch the identified direct deposit payment destination account; where the switching process of the direct deposit payment destination account is started without further interactions from the user and the switch is fulfilled so future direct deposit payments are deposited into the new destination account.

In some variations, one or more of the features disclosed herein including the following features can optionally be included in any feasible combination. The server system may use an identifier sent along with the request to identify additional information needed to generate a switch of direct deposit payment destination account. The identifier may identify the client system and the server system may provide the identifier to the client system. The client system and server system may communicate via the Internet. The displaying may include displaying information provided by the server system. The server system may send to the client system a confirmation that the switching process has started and a confirmation that the switching process has completed. The single action may be clicking a mouse button or tapping of a touch screen device when a cursor or finger is positioned over a predefined area of the displayed information. The single action may be a sound generated by a user. The single action may be depressing of a key on a key pad. The single action may be selecting or swiping using a pointing device. The single action may be a selection of a displayed indication. The single action may be authentication with finger-print reader. The single action may be authentication with face recognition. The displaying may include displaying partial information supplied by the server system as to the identity of a user of the client system. The displaying may include displaying partial employer information supplied by the server system. The displaying may include displaying partial direct deposit payment destination account information supplied by the server system.

In another inter-related aspect, a method for switching of a direct deposit payment destination account may include: receiving, from a client system, a request for switching a direct deposit payment, the request including an identifier identifying a user of the client system; mapping the received identifier to the user; transmitting, to the client system, employer information associated with the user and data for generating a single action indicator at the client system; receiving, from the client system, a selection of the single action indicator; generating, in response to receiving the selection, a process to complete the switching of the direct deposit payment; and transmitting, to the client system, a notification confirming completion of the process.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to improving the speed and efficiency of processing online transactions, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 illustrates screenshots of an exemplary single action switching process, in accordance with some implementations;

FIG. 2 illustrates a diagram of a system comprising a client system in communication with a server system, in accordance with some implementations; and

FIG. 3 illustrates a flowchart of a method for completing a single action switching process, in accordance with some implementations.

When practical, similar reference numbers denote similar structures, features, or elements.

### DETAILED DESCRIPTION

Implementations of the current subject matter includes methods, devices, apparatuses, articles of manufacture, and systems relating to improving the speed and efficiency of processing online transactions.

In some aspects, an online transaction can include switching or initializing a direct deposit payment destination for an employee of a company. Since the switching of direct deposit payment destination account information contains sensitive information (e.g., account numbers and social security numbers), both users and financial institutions may find it desirable to ensure the security of such information. Security is a concern because information transmitted over the Internet may pass through various intermediate computer systems on its way to its final destination. The information could be intercepted by an unscrupulous person at an intermediate system. To help ensure the security of the sensitive information, various encryption techniques are used when transmitting such information between a client device and a server computer system. Even though such encrypted information can be intercepted, because the information is encrypted, it is generally useless to the interceptor. Nevertheless, there can be a possibility that such sensitive information may be successfully decrypted by the interceptor. Therefore, it would be desirable to minimize the sensitive information transmitted when switching direct deposit payment destination account.

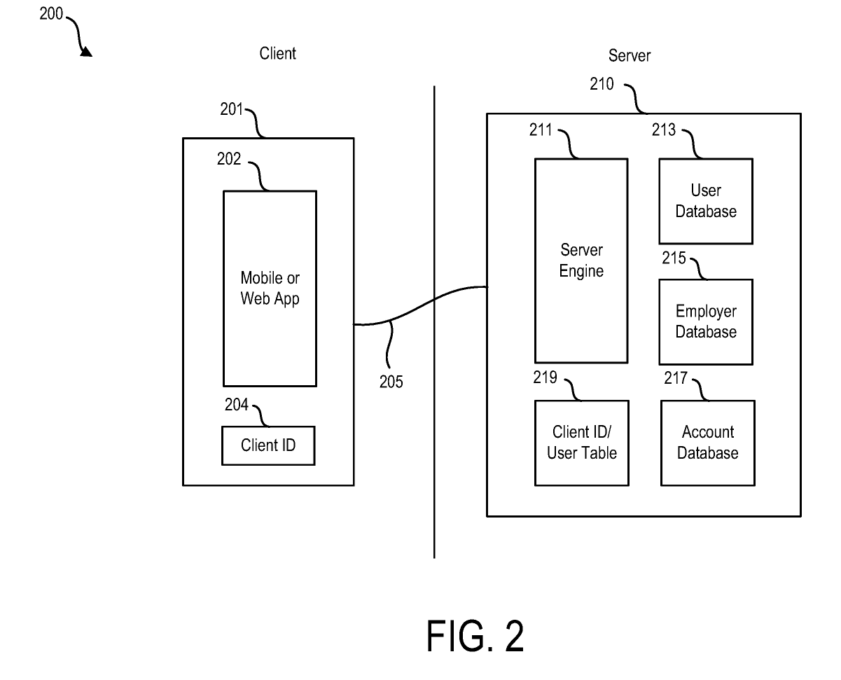

An embodiment of the present disclosure provides a method and system for switching direct deposit payment destination account with an easy or single action from a client system. In some implementations, a client system (e.g., client system 201 of FIG. 2 below) is provided with an identifier that identifies a customer. The client system displays information that identifies the item and displays an indication of an action (e.g., a single action such as clicking a mouse button, a touch on a screen, clicking or tapping a button, speaking a sound, a voice, a facial movement, a facial gesture, a body gesture, a fingerprint, a biometrics identifier, a camera image, or a video) that a user desires to switch a direct deposit payment from his or her employer to a destination account. In some aspects, the client system displays the information on a user interface of a computing apparatus (e.g., monitor, smart phone screen, tablet, etc.). In response to the indicated action being performed, the client system sends to a server system (e.g., server system 210 of FIG. 2 below) the provided identifier and a request to switch direct deposit payment to a destination account. The server system can be configured to use the identifier to identify additional information needed to generate a request switching direct deposit payment to a destination account and then starts the switching process.

In some implementations, the server system receives and stores the additional information for users using various computer systems so that the server system can generate such requests. The server system stores the received additional information associated with an identifier of the user and provides the identifier to the client system. When requested by the client system, the server system can provide information describing the employer of the user to the requesting client system. When the server system receives a request from a client system, the server system can combine the additional information stored and associated with the identifier included in the request to effect the switching of direct deposit payment to a destination account.

The present disclosure provides a method and system for easy and/or single action switching of direct deposit payment destination account in a client/server environment. The single action switching system of the present disclosure reduces the number of user interactions needed to request a switch and reduces the amount of sensitive information that is transmitted between a client system and a server system. The single action switching can also reduce the processes and/or tasks need to accomplish such a transaction, thus improving speed and efficiency of the client and/or server system.

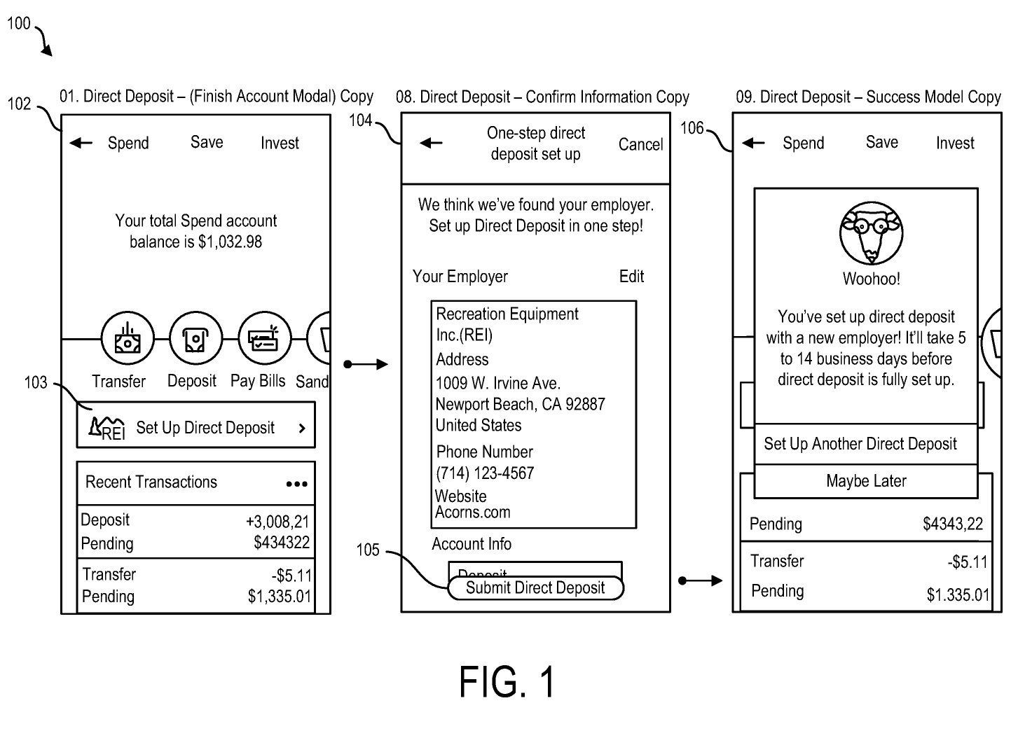

FIG. 1 illustrates screenshots of an exemplary single action switching process 100, in accordance with some implementations. The screenshots depict a sequence of three screens 102, 104, and 106 in a mobile application going through the switching process 100. The screen 102 on the left presents a home screen with an indication 103 indicating that an opportunity to switch or set up a direct deposit payment destination account is available. In some aspects, the screen 102 may be associated with a bank and/or bank account or financial institution and/or financial institution account of the user of the mobile application. The middle screen 104 presents a pre-filled employer information display that the user can verify comprise accurate information, as well as a single action button 105 at the bottom of the screen 104. The pre-filled employer information on the screen 104 can be sent from the server system (e.g., server system 210 of FIG. 2) to the client system (e.g., client system 201 of FIG. 2) in response to the user selecting the indication 103 on screen 102. In some aspects, the selection of the indication 103 can request that the user review the detailed information about the employer displayed on screen 104. In some implementations, after the user taps the single action button 105, the right screen 106 appears to acknowledge that the request for a switch of direct deposit payment destination account is being processed. In some aspects, the server system can provide the data to the client device and/or mobile application for the mobile application to generate the right screen 106.

FIG. 2 is a diagram of a system 200 comprising a client system 201 in communication with a server system 210, in accordance with some implementations. The system 200 can support the single action switch over a communication network 205 such as the Internet, a cellular network, WiFi, LAN, WLAN, Bluetooth, near field communication, or any other communication network. As shown in FIG. 2, the server system 210 comprises a server engine 211, a user database 213, employer database 215, an account database 217, and a client identifier/user table 219. As further shown in FIG. 2, the client system 201 comprises mobile or web application 202 and a client identifier (ID) 204.

In some implementations, the server engine 211 receives requests from one or more client systems 201 over the communication network 205 to provide user-specific employer information for switching of direct deposit payment destination account to the various client systems. The server engine 211 can comprise a receiver and/or a transceiver for receiving requests and communicating with client system 201. Such an information request from the client system 201 may indicate that a user of the client system 201 would like to consider switching direct deposit payment destination account. If the user performs the single action switch (e.g., selecting the single action button 105 of FIG. 1), the client system 201 can communicate the action along with the Client ID. In response to the server system 210 receives this communication, the server system 210 can construct a user-specific request for the switching of direct deposit payment destination account. The user-specific request can include information from the user database 213, which includes information associated with the user's transactions. The employer database 215 includes employers' direct deposit process information. The account database 217 includes a set of bank accounts or other financial institution accounts that the direct deposit payments will be deposited into. In some aspects, the user-specific request for the switching of direct deposit payment destination account can be communicated from the server system 210 to the user's employer and/or bank and/or financial institution account in order to complete the switch or initial set up of a direct deposit payment.

In one implementation, the server system 210 can assign a unique client identifier (e.g., Client ID 204) to each client system 201 that is in communication with the server system 210. The server system 210 can also store user-specific switching information for various potential employers. For example, the user-specific switching information can be stored in one or more of the user database 213, employer database 215, account database 217, and the client ID/user table 219. The user-specific switching information can be collected from previous interactions with the user and the server system 210. The server system 210 can maps each client ID 204 to a user that may use that client system 201 to request a switch of direct deposit payment destination account. In some aspects, when a user wants to request a switch of direct deposit payment destination account, the user can use a client system 201 to send the request to the server system 210 for switching along with its client ID 204. In some aspects, the request is transmitted in response to a user selecting a single action button (e.g., single action button 105 of FIG. 1).

In some aspects, the server system 210 determines whether the client ID 204 for that client system 201 is mapped to a user. If so mapped, the server system 210 can send the requested information to the client system 201 along with an indication of the single action to perform to switch direct deposit payment destination account. For example, the server system 210 can transmit the requested information and the indication of the single action to the client system 201. The client system 201 and/or the mobile application 202 can be configured to generate a user interface (e.g., screen 104) displaying the information and the single action button. When the user performs that single action, the client system 201 can communication that selection/action to the server system 210 over network 205. The server system 210 can then complete the request to switch by adding the user-specific switching information for the user that is mapped to that client ID 204 to the switching information (e.g., employer information). Thus, once the description of an employer is displayed (e.g., on screen 104), the user need only take a single action (e.g., select single action button 105) to request a switch of direct deposit payment destination account. Also, since the client ID 204 identifies user-specific switching information already stored at the server system 210, there is no need for such sensitive information to be transmitted via the Internet or other communications medium.

One skilled in the art would appreciate that the single action ordering techniques can be used in various environments other than the mobile Internet. For example, single action ordering can also be in an electronic mail environment in which a switching opportunity is described in an electronic mail message along with an indication of the single action that is to be performed to effect the switching of the account. Also, the server system 210 may comprise any combination of hardware or software that can generate switch requests in response to the single action being performed. A client system may comprise any combination of hardware or software that can interact with the server system.

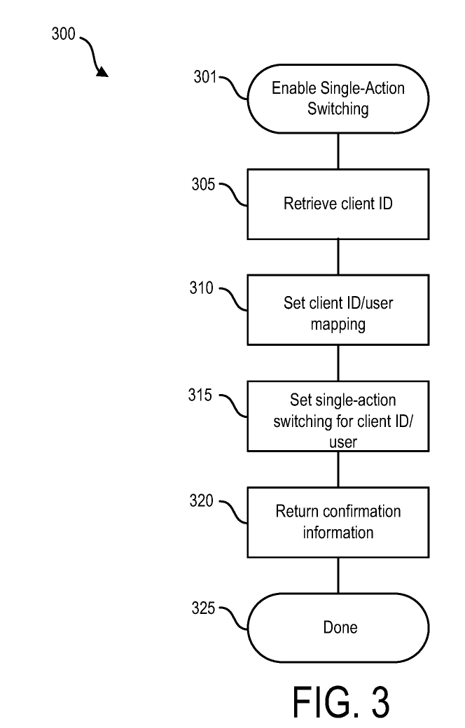

FIG. 3 is a flowchart of a method 300 for completing a single action switching process, in accordance with some implementations. In some aspects, the steps of the method 300 can be performed by the client system 201 and/or the server system 210. As shown in FIG. 3, the method 300 begins at block 301 where a server system 210 can be configured to enable single action switching. At block 305, to enable single action switching, the server system 210 can retrieve certain information about the user that is equivalent to the employer-specific switching information. At block 305, the server system retrieves the client identifier (e.g., client ID 204) sent by the client system 201. The server system 210 can obtain this information in various ways. First, the server system 210 could prompt the user via client system 201 for the employer-specific switch information. Second, the server system 210 could also save the employer-specific switch information collected when another employee or contractor of the same employer did a switch. The server system could, either automatically or with the user's assent, enable single action switching. At block 310, the server system 210 can set the client ID/user mapping. In some aspects, setting the client ID/user mapping can comprise updating the client identifier/user table 219 to indicate that the generated client ID 204 has been associated/mapped with that user of the client system 201. At block 315, the server system 210 can configure the single action switching for the client ID/user. In some aspects, configuring the single action switching can include setting a flag indicating that single action switching is enabled for that client ID 204 and user combination. In some implementations, the flag may be stored in the client identifier/user table 219. At block 320, the server system 210 can return confirmation information to the client system 201. In some instances, the return confirmation may be cached if the connectivity is temporarily not available and later sent when connectivity is restored. In some aspects, the server system 210 supplies a confirming Web page or user interface to the client system 201. At block 325, the method ends.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to a given example, the features and elements so described or shown can apply to other implementations of the current subject matter. It will also be appreciated by those of skill in the art that references to a structure or feature that is disposed “adjacent” another feature may have portions that overlap or underlie the adjacent feature.

Terminology used herein is for the purpose of describing particular implementations and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification and in the claims, specify the presence of stated features, steps, operations, elements, and/or components, but do not preclude the presence or addition of one or more other features, steps, operations, elements, components, and/or groups thereof.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

Although various illustrative implementations are described above, any of a number of changes may be made to various implementations without departing from the teachings herein. For example, the order in which various described method steps are performed may often be changed in alternative implementations, and in other alternative implementations one or more method steps may be skipped altogether. Optional features of various device and system implementations may be included in some implementations and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor or a smart speaker for displaying or presenting information to the user and a keyboard or a touch screen, or a camera or a microphone, and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The examples and illustrations included herein show, by way of illustration and not of limitation, specific implementations in which the subject matter may be practiced. As mentioned, other implementations may be utilized and derived there from, such that structural and logical substitutions and changes may be made without departing from the scope of this disclosure. Such implementations of the inventive subject matter may be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description.

What is claimed is:

1. A method of switching of direct deposit payment destination account comprising:
displaying, under control of a client system, information identifying an employer;
sending, in response to a single action being performed, a request to switch a direct deposit payment destination, along with an identifier of a user making the switch, to a server system;
receiving, at a single action switch component of the server system, the request;
retrieving, at the server system and in response to the receiving, additional information previously stored for the user identified by the identifier in the received request;
generating a second request to switch the direct deposit payment destination for the user identified by the identifier in the received request using the retrieved additional information; and
fulfilling the generated request to complete switch of the direct deposit payment destination, wherein a process of switching direct deposit payment destination can be started without using multiple user interaction steps.

2. The method of claim 1, wherein the displaying of information includes displaying information indicating the single action.

3. The method of claim 1, wherein the single action is one of clicking or tapping a button, speaking a sound, a facial movement, a facial gesture, or a body gesture.

4. The method of claim 1, wherein a user of the client system does not need to explicitly identify themselves when placing an order.

5. A client system for switching of direct deposit payment destination account comprising:
an identifier that identifies a user;
a display component for displaying information identifying the employer of the direct deposit payment; and
a single action switching component that, in response to performance of a single action, sends a request to a server system to switch direct deposit payment destination account, the request including the identifier so that the server system can locate additional information needed to complete the switch and so that the server system can fulfill the generated request to complete switching of the direct deposit payment destination,
wherein a process of switching direct deposit payment destination can be started without using multiple user interaction steps.

6. The client system of claim 5, wherein the display component is a browser or a mobile app.

7. The client system of claim 5, wherein the single action is one of a clicking of a mouse button, a tap of a touch screen device, a voice, a finger print, a biometrics identifier, a facial movement, a camera image, a video, or a body gesture.

8. A server system for switching of direct deposit payment destination account comprising:
a direct deposit payment destination switching processor component; and
a single action direct deposit payment destination switching component comprising:
a data storage medium configured to store information for a plurality of users;
a receiving component configured to receive a request to switch direct deposit payment destination, the request including an indication of one of the plurality of users, the request sent in response to only a single action being performed;
a direct deposit payment destination switching component configured to retrieve from the data storage medium information for the indicated user and that uses the retrieved information to switch the direct deposit payment for the indicated user for an employer; and
a direct deposit payment destination switching processor component that completes the switch in accordance with the order placed by the single action ordering component.

9. The server system of claim 8, wherein the request is sent by a client system in response to a single action being performed.

10. A method for switching of a direct deposit payment destination account using a client system, the method comprising:
displaying, on a user interface of the client system, information identifying an employer of a direct deposit payment and displaying an indication of a single action that is to be performed to switch direct deposit payment destination account; and
sending, in response to the indicated single action being performed, to a server system a request to switch the identified direct deposit payment destination account,
wherein the switching process of the direct deposit payment destination account is started without further interactions from the user and the switch is fulfilled so future direct deposit payments are deposited into the new destination account.

11. The method of claim 10, wherein the server system uses an identifier sent along with the request to identify additional information needed to generate a switch of direct deposit payment destination account.

12. The method of claim 11, wherein the identifier identifies the client system and the server system provides the identifier to the client system.

13. The method of claim 10, wherein the client system and server system communicate via the Internet.

14. The method of claim 10, wherein the displaying includes displaying information provided by the server system.

15. The method of claim 10, including sending from the server system to the client system a confirmation that the switching process has started and a confirmation that the switching process has completed.

16. The method of claim 10, wherein the single action is clicking a mouse button or tapping of a touch screen device when a cursor or finger is positioned over a predefined area of the displayed information.

17. The method of claim 10, wherein the single action is a sound generated by a user.

18. The method of claim 10, wherein the single action is depressing of a key on a key pad.

19. The method of claim 10, wherein the single action is selecting or swiping using a pointing device.

20. The method of claim 10, wherein the single action is selection of a displayed indication.

21. The method of claim 10, wherein the single action is authentication with finger-print reader.

22. The method of claim 10, wherein the single action is authentication with face recognition.

23. The method of claim 10, wherein the displaying includes displaying partial information supplied by the server system as to the identity of a user of the client system.

24. The method of claim 10, wherein the displaying includes displaying partial employer information supplied by the server system.

25. The method of claim 10, wherein the displaying includes displaying partial direct deposit payment destination account information supplied by the server system.

26. A method for switching of a direct deposit payment destination account, the method comprising:
receiving, from a client system, a request for switching a direct deposit payment, the request comprising an identifier identifying a user of the client system;
mapping the received identifier to the user;
transmitting, to the client system, employer information associated with the user and data for generating a single action indicator at the client system;
receiving, from the client system, a selection of the single action indicator;
generating, in response to receiving the selection, a process to complete the switching of the direct deposit payment; and
transmitting, to the client system, a notification confirming completion of the process.
